(19) United States
(12) Patent Application Publication
(10) Pub. No.: US 2026/0236559 A1
(43) Pub. Date: Aug. 13, 2026

(54) ROBUST PREFERENCE DATA FOR RIGOROUS ALIGNMENT OF LLMS

(71) Applicant: THE BOARD OF TRUSTEES OF THE UNIVERSITY OF ILLINOIS, URBANA, IL (US)

(72) Inventors: Son THE NGUYEN, Chicago, IL (US); Niranjan Uma NARESH, Chicago, IL (US); Theja TULABANDHULA, Chicago, IL (US)

(21) Appl. No.: 19/536,959

(22) Filed: Feb. 11, 2026

Related U.S. Application Data
(60) Provisional application No. 63/757,178, filed on Feb. 11, 2025.

(51) Int. Cl. G06F 17/16; G06N 7/01

(52) U.S. Cl. CPC G06F 17/16; G06N 7/01

(57) ABSTRACT

Disclosed is a system and method of aligning large language models (LLMs) with human values via preference learning (PL), focusing on incomplete and corrupted data in preference datasets. The method provides a guaranteed polynomial time ranking algorithm that recovers an ϵ-optimal ranking with high probability while allowing as large as O(ₙ) perturbed pairwise comparison results per model response. Experiments confirm these methods handle adversarial noise and unobserved comparisons well in both general and LLM preference dataset settings. The method aligns AI models by equipping the dataset curation pipeline with the ability to handle missing and maliciously manipulated inputs.

### RELATED APPLICATIONS

This application claims the benefit of priority under 35 U.S.C. § 119 to U.S. Provisional Application No. 63/757,178, filed on Feb. 11, 2025, the entire contents of which are incorporated herein by reference.

### BACKGROUND OF THE INVENTION

Large Language Models (LLMs) are highly advanced Artificial Intelligence (AI) systems capable of understanding, interpreting, and generating languages. The integration of AI chatbots like ChatGPT into our daily lives and businesses has had a profound impact on both society and industries (Eloundou et al., 2023). These models have evolved from being specialized tools in specific fields to versatile assets that are increasingly applied in everyday activities and diverse work environments (Nguyen et al., 2023). However, the success of GPTs/LLMs depends not only on their ability to generate responses and perform tasks well but also on their alignment with human values and expectations.

Prior to ChatGPT, AI language models and chatbots often produced undesirable answers, making them unfit for public use. Examples of this problem include Microsoft's Tay chatbot (Lee, 2016), the National Eating Disorders Association's Tessa (Mccarthy, 2023), and Google's Meena/LaMDA (Adiwardana et al., 2020). Although Meena/Lambda's release was initially stopped due to not complying with Google's AI safety and fairness guidelines, the project was later released publicly as Bard because of pressure from ChatGPT and BingChat (Mok, 2023). Unfortunately, its factual error ended up costing Alphabet $100 billion in market cap (Wittenstein, 2023). The most recent AI incident at the time of writing involved Gemini's image generation AI model, which was found to be biased in favor of certain minority groups, leading Google to shut it down (Gordon, 2024). Attempts have been made to address these problems by measuring the personality traits of large language models and modifying them through fine-tuning techniques (Karra et al., 2023). However, it was not until Instruct-GPT (Ouyang et al., 2022) was released with Reinforcement Learning from Human Feedback (RLHF) (Ouyang et al., 2022), that marked a significant breakthrough in aligning LLMs effectively with human values. RLHF has paved the way for OpenAI's ChatGPT to reshape industries, and GPT-4 to be considered a preliminary form of artificial general intelligence (AGI) (Bubeck et al., 2023), a type of AI that is vastly more intelligent than humans.

Alignment is a crucial step in steering AI models toward the desired outcomes that align with human values/intentions. The prevalent method for aligning AI/LLMs currently involves preference learning (PL) through RLHF or Reinforcement Learning from AI Feedback (RLAIF) (Lee et al., 2023) using Proximal Policy Optimization (PPO) (Schulman et al., 2017), or alternatively, employing Direct Preference Optimization (DPO) (Rafailov et al., 2023). While PPO is a reinforcement learning (RL) technique within the RLHF pipeline, DPO directly integrates human preferences into the LLMs.

PL is an effective method, but it comes with a cost. This method requires high-quality human preference data (Touvron et al., 2023b). Acquiring human preference for LLMs is a time-consuming and expensive process that requires enormous resources and hiring of qualified human labelers to ensure data quality (Bai et al., 2022; Lee et al., 2023). For LLaMa-2, while there was very limited information in the development of the model, the training cost was estimated to be between $20-45 million, with $8 million spent solely on preference data (Lambert, 2023). Even for large AI companies like Google, Meta, OpenAI, and Anthtropic, it is often not feasible to account for all human values and cultures. Recent research by OpenAI shows that RLHF may not be able to scale to supervise AGI models reliably (Burns et al., 2023). One solution for the scaling problem is to crowdsource preference data collection to the general public, which significantly reduces costs and provides a more diverse set of human values. However, scaling up the collection of human preferences using this type of crowdsourcing often results in poor-quality data that is incomplete or adversarially corrupted. Participants may unintentionally or intentionally provide incomplete, inaccurate, or harmful feedback, as highlighted by (Casper et al., 2023; Draws et al., 2021; Daniel et al., 2018; Cocos et al., 2017). Using such data directly to train AI can result in suboptimal AI systems that are biased, have misaligned behaviors, or can lead to outcomes that are unfair, discriminatory, or harmful (FIG. 1). Deploying models trained with poor-quality preference data can erode trust in AI systems, especially if they are used in critical applications. Users may lose confidence in the model's ability to perform tasks accurately and align with their expectations and ethical standards, as mentioned in the examples above. Therefore, ensuring the reliability and integrity of preference datasets for aligning strong LLMs and AGI becomes challenging as the process scales up with large-scale responses and unscreened participants.

However, very large-scale collection of human preferences data (preference data) results in 1) incomplete, 2) inaccurate or harmful feedback (from the viewpoint of provider safety guidelines). Therefore, there is a need for a preference data processing/alignment management system that provides a ranking output and recovery from adversarial and corrupted human preference data that enables scalability and reduces associated costs.

### SUMMARY OF THE INVENTION

Disclosed herein is a preference data processing and alignment management system. provides a guaranteed polynomial time ranking algorithm that recovers an ϵ-optimal ranking with high probability while allowing as large as O(ₙ) perturbed pairwise comparison results per model response.

In various exemplary embodiments, disclosed is a preference data processing and alignment management system comprising: obtaining raw and optionally, in some exemplary embodiments, when the raw data is fully observed and adversarially corrupted, processing the raw data by algorithm 3, to provide an estimate of entries of P-hat (\hat{p}) for i≤j providing a recovered dataset. In these embodiments, processing the recovered dataset with a robust principal component analysis (RPCA) algorithm to provide to provide a completed dataset; and processing the recovered dataset by algorithm 2 (procedure 2) to provide a pairwise ranking of the data comprising a revised PL dataset, wherein a large language model (LLM) uses the revised PL dataset from the algorithms 3, 4, or 5 to align the LLM with user preferences.

Optionally, in various exemplary embodiments of the system, when the data is partially observed and uncorrupted, the raw data is processed by an OptSpace algorithm (algorithm 4) (CORATRON) to provide a completed dataset. In these embodiments, the completed dataset is processed by algorithm 2 (procedure 2) to provide a pairwise ranking of the data to comprise a revised PL dataset.

In various other exemplary embodiments of the system, when the raw data is partially observed and adversarially corrupted the raw data is processed by an OptSpace algorithm (algorithm 5) (CURATRON) to provide a recovered dataset. In this embodiment, the recovered dataset is processed by a robust principal component analysis (RPCA) algorithm to provide a completed dataset; and the completed dataset is processed by an algorithm 2 (procedure 2) to provide a pairwise ranking of the data to comprise a revised PL dataset. In these embodiments, a large language model (LLM) uses the revised PL dataset from the algorithms 3, 4, or 5 to align the LLM with user preferences.

In yet other exemplary embodiments, disclosed is a computer-implemented method to train or guide alignment of preference data of large language models for preference learning (PL) in an artificial intelligence agent. The method comprising: obtaining raw data and optionally, in some exemplary embodiments, when the raw data is fully observed and adversarially corrupted, processing the raw data by algorithm 3, to provide an estimate of entries of P-hat (\hat{p}) for i≤j providing a recovered dataset. In these embodiments, processing the recovered dataset with a robust principal component analysis (RPCA) algorithm to provide to provide a completed dataset; and processing the recovered dataset by algorithm 2 (procedure 2) to provide a pairwise ranking of the data comprising a revised PL dataset, wherein a large language model (LLM) uses the revised PL dataset from the algorithms 3, 4, or 5 to align the LLM with user preferences.

In various other embodiments, when the raw data is fully observed and adversarially corrupted, processing the raw data by algorithm 3, to provide an estimate of entries of P-hat (\hat{p}) for i≤j providing a recovered dataset. In these embodiments, processing the recovered dataset with a robust principal component analysis (RPCA) algorithm to provide to provide a completed dataset; and processing the recovered dataset by algorithm 2 (procedure 2) to provide a pairwise ranking of the data comprising a revised PL dataset, wherein a large language model (LLM) uses the revised PL dataset from the algorithms 3, 4, or 5 to align the LLM with user preferences.

In still other exemplary embodiments, when the raw data is partially observed and adversarially corrupted, processing the raw data by a second OptSpace algorithm (algorithm 5) to provide recovered dataset; and processing the recovered dataset by a robust principal component analysis (RPCA) algorithm (procedure 1) to provide a completed dataset. In these embodiments, processing the completed dataset by algorithm 2) (procedure 2) to provide a pairwise ranking of the data comprising a revised PL, dataset, wherein a large language model (LLM) uses the revised PL dataset from the algorithms 3, 4, or 5 to align the LLM with user preferences.

These and other features and advantages of this invention will be more fully understood from the following detailed description of the invention taken together with the accompanying claims. It is noted that the scope of the claims is defined by the recitations therein and not by the specific discussion of features and advantages set forth in the present description.

### BRIEF DESCRIPTION OF DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1: CURATRON corrects incomplete and adversarially corrupted preference data to improve RLHF/DPO alignment results compared to using the raw initial preference data.

FIGS. 2a, 2b, and 2c: Three settings/scenarios where incomplete data and adversarial corruption can affect LLMs: (a) Fully observed and adversarially corrupted setting, (b) Partially observed and uncorrupted setting, and (c) Partially observed and adversarially corrupted setting.

FIG. 3: Robust recovery results of the BTL model: we fix v=2 and vary d in the left plot; we fix d=100 and vary v in the left plot. The black line represents RORATRON, the blue line represents Maximum Likelihood (ML), the pink line represents Rank Centrality (RC), and the red line represents Borda Count (BC).

FIG. 4: Left: Original matrix. Middle: corrupted matrix. Right: reconstructed matrix. The corrupted matrix has 10% adversarial corruptions and 10% of unobserved comparisons. We use our CURATRON algorithm to successfully recover the original matrix.

FIG. 5: Average over 5 runs of reconstruction error, correlation, and distance between reconstructed ranking and original ranking for different percentages of unobserved and adversarial comparisons.

FIG. 6: A prompt template and answer of LLM judge.

### DETAILED DESCRIPTION

Disclosed herein is a method that provably recovers an ϵ-optimal ranking with high probability while allowing as large as O(n) perturbed pairwise comparison results per model response. Furthermore, shown are robust recovery results in the partially observed setting. Experiments confirm that the algorithms disclosed handle adversarial noise and unobserved comparisons well in both general and LLM preference dataset settings. This work contributes to the development and scaling of more reliable and ethically aligned AI models by equipping the dataset curation pipeline with the ability to handle missing and maliciously manipulated inputs.

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Computer Hope (https: www.computerhope.com), or the Computer Dictionary of Information Technology (https://www.computer-dictionary-online.org/).

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit. For example, one or more substituents on a phenyl ring refers to one to five substituents on the ring.

As will be understood by the skilled artisan, all numbers, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of 5%, 10%, +20%, or ±25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include values, e.g., weight percentages, proximate to the recited range that are equivalent in terms of the functionality of the individual ingredient, composition, or embodiment. The terms “about” and “approximately” can also modify the endpoints of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units is also disclosed. For example, if 10 to 15 is disclosed, then 11, 12, 13, and 14 are also disclosed, individually, and as part of a range. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

This disclosure provides ranges, limits, and deviations to variables such as volume, mass, percentages, ratios, etc. It is understood by an ordinary person skilled in the art that a range, such as “number 1” to “number 2”, implies a continuous range of numbers that includes the whole numbers and fractional numbers. For example, 1 to 10 means 1, 2, 3, 4, 5, . . . 9, 10. It also means 1.0, 1.1, 1.2. 1.3, . . . , 9.8, 9.9, 10.0, and also means 1.01, 1.02, 1.03, and so on. If the variable disclosed is a number less than “number 10”, it implies a continuous range that includes whole numbers and fractional numbers less than number 10, as discussed above. Similarly, if the variable disclosed is a number greater than “number 10”, it implies a continuous range that includes whole numbers and fractional numbers greater than number 10. These ranges can be modified by the term “about”, whose meaning has been described above.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “substantially” as used herein, is a broad term and is used in its ordinary sense, including, without limitation, being largely but not necessarily wholly that which is specified. For example, the term could refer to a numerical value that may not be 100% the full numerical value. The full numerical value may be less by about 1%, about 2%, about 3%, about 4%, about 5%, about 6%, about 7%, about 8%, about 9%, about 10%, about 15%, or about 20%.

Wherever the term “comprising” is used herein, options are contemplated wherein the terms “consisting of” or “consisting essentially of” are used instead. As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the aspect element. As used herein, “consisting essentially of” does not exclude materials or steps that do not materially affect the basic and novel characteristics of the aspect. In each instance herein any of the terms “comprising”, “consisting essentially of” and “consisting of” may be replaced with either of the other two terms. The disclosure illustratively described herein may be suitably practiced in the absence of any element or elements, limitations, or limitations not specifically disclosed herein.

As used herein, the term “adversarially corrupted” refers to data that is intentionally incomplete, inaccurate, or harmful feedback provided by an individual.

As used herein, the term “strong LLM” refers to a large language model (LLM) that demonstrates high performance across various tasks, including generating accurate and relevant text, understanding complex questions, and performing well on benchmark tests, essentially signifying a high level of capability and fluency in language processing compared to other LLMs; it is often considered a benchmark for quality when evaluating other models.

As used herein, “LLM Alignment” refers to making sure that AI language models act in ways that are safe and match what we expect. It's like teaching a robot to understand and follow human rules, and our response preferences to certain words or commands.

“Aligning LLMs and AGI” refers to the process of ensuring that large language models (LLMs) are designed and trained in a way that their outputs and behaviors closely align with human values and goals, with the ultimate aim of creating an Artificial General Intelligence (AGI) that acts in a safe and beneficial manner, essentially making sure the AI system does what humans intend it to do.

Low rank matrix, in linear algebra, refers to a matrix whose rank, the number of linearly independent rows or columns, is significantly smaller than its total number of rows and columns.

“Low ranking”, in preference learning models, refers to a situation where a model consistently predicts an option as less preferred compared to other available options, essentially placing it near the bottom of a ranked list when evaluating different choices based on user preferences; it indicates the model has a low accuracy in identifying the most preferred option, often due to issues with the training data or the corrupted or incomplete data.

Ensuring the reliability and integrity of preference datasets for aligning strong LLMs and AGI becomes challenging as the process scales up with large-scale responses and unscreened participants. Approaching the issues, we consider the following learning problem. Suppose there are n responses we wish to order based on a notion of comparison, between every pair of responses, with probabilistic outcomes. Further, we are given a set [symbol] ={(i,j{y^{k}ᵢⱼ})}, consisting of K independent pairwise comparison outcomes, denoted by {y^{k}}∈{0, 1}, k∈[K], between pairs of responses (i,j), ⊆[n]×[n], a significant proportion of which might be corrupted by an adversary. In this passive learning setting, the concrete questions we wish to address are:
1. Is it possible to identify the pairs whose comparison results were corrupted by an adversary?
2. Having identified the corrupted results, as desired, is it possible to filter them out while computing a global ranking of the n responses?
3. Is this task tractable statistically and computationally?
4. If so, is it possible to construct a provably correct and efficient algorithm, and what are the associated properties?
5. Further, does it work well in practice when we may also encounter unobserved data?

This disclosure answers the above questions in the affirmative as follows.
1. Problem formulation: We give a generic definition of (additive) adversarial noise, which can be handled for a broad class of statistical models, including the classic BTL model and also certain extensions of it such as the general Low-Rank (LR) models (Rajkumar and Agarwal, 2016). As is the case with standard estimation techniques, if the noise is not modeled and handled well, we show that the quality of the estimated ranking could be quite bad, by quantifying the error of the estimated ranking with respect to the best possible ranking.
2. Algorithms & guarantees: Under certain (information-theoretically tight) identifiability assumptions on the properties of the adversary, we develop a correct and efficient ranking method, Robust Preference Data for Rigorous Alignment (RORATRON), that guarantees ϵ-accurate high-probability learnability in a manner that is ‘robust’ and oblivious to the effects of the adversary. Our learning algorithm is provably characterized by polynomial time computational complexity.
In practice, it is often the case that not all pairs are compared, and even the observed pairwise comparison data could be adversarially corrupted—we also develop Complete Robust Preference Data for Rigorous Alignment (CURATRON) and characterize the conditions for guaranteed robust recovery in this scenario. This results in a practical implication of enhancing preference data collection efficiency by automatically generating complete datasets from limited missing preference data.
3. Experiments: Finally, we support our theoretical results by showing robust ranking results on both synthetic and real-world experiments. Our experiments demonstrate the potential of our method in helping create large-scale AI/LLMs that are more accurately aligned with human values using minimal human effort as we achieved high reconstruction accuracy despite severe data missing and corruption.

However, these methods require high-quality human supervision through pairwise or ranking preference data, which is often noisy and not practical in real-world scenarios (Casper et al., 2023). Trying to address this issue, robust DPO (rDPO) (Chowdhury et al., 2024), conservative DPO (cDPO) (Mitchell, 2023), and Identity Preference Optimization (IPO) (Azar et al., 2023) losses are proposed to solve the problem of noisy preference data. An alternative solution to reduce dependence on human data is to utilize Constitutional AI/AIF (Bai et al., 2022; Lee et al., 2023). This approach aims to minimize human inputs by using other LLMs/models (Jiang et al., 2023b), or by self-critiquing and improving its outputs (Chen et al., 2024; Yuan et al., 2024) based on user-defined principles.

Our proposed approach to scaling up PL is different from previous work. Instead of creating new loss functions or using other models/LLMs themselves to remove humans outside of the loop, we aim to make PL with human feedback easier to manage by explicitly solving the problems associated with it. We develop low-cost and computationally efficient algorithms that take into account the low-rank characteristic of pairwise human preference data, which helps us address issues such as incomplete and adversarial corruptions in human preference datasets.

Ranking Models: In the BTL model, item i has an associated score wᵢ, then, the probability that item is preferred over j is given by Pᵢⱼ=e^{-w}i/(e^{-wi}+e^{-wj} where w∈ [symbol] is the BTL parameter vector to be estimated from data; here, P∈ [symbol] is called the ‘preference matrix’. A closely related model, in the non-active setting, is the recently proposed LR model (Rajkumar and Agarwal, 2016) wherein a generic class of preference matrices is characterized to be those having low rank under transformations using certain functions; specifically, for BTL-like models, the logit function defined as ψ(x)=log (x/(1−x)) turns out to right choice as shown in their paper. However, while their model accounts for missing information, they do not consider the harder problem of handling adversarial noise. Several robust ranking heuristics have been proposed (for example, (Wang et al., 2012; Zhou et al., 2011)), but these approaches do not have theoretical guarantees associated with them. The Sync-Rank algorithm proposed in (Cucuringu, 2016) handles noise models different from the one considered in the preset work and is based on spectral techniques. Another related work is (Rajkumar and Agarwal, 2014) which proposes the so-called ‘Generalized Low-Noise’ (GLN) condition that ∀≠j, Pᵢⱼ>Pⱼᵢ=Σⁿₕ₌₁αₕPₕᵢ for α∈Rⁿ. When αₕ=1, ∀h, they analyze the sample complexity and show convergence properties of various popular ranking algorithms like:

Maximum Likelihood (ML): this entails solving arg max_{w} Σ_{i<j}(\hat{p}ᵢⱼ(wⱼ−wᵢ)−log(1+exp(wⱼ−wᵢ))) where w∈ [symbol] is the BTL parameter vector and \hat{p}ᵢⱼ is the empirical preference matrix.

1. Rank Centrality (RC) (Negahban et al., 2012): here, one sorts items by their scores which are computed as the stationary distribution of an appropriately normalized empirical preference matrix; this approach has a known sample complexity guarantee of O(n log (n)).

2. Borda Count (BC) (Jiang et al., 2011): this heuristic involves ranking an item according to the fraction of times it beats other items.

For the general case α (which previous methods fail to handle), they also propose a noise-tolerant SVM-based method for rank aggregation. However, in the adversarial setting, we consider in this paper, GLN could be violated and hence requires a different algorithmic approach and analysis.

Robust Subspace Recovery: It is well-known that Principal Component Analysis (PCA), a ubiquitous technique for subspace identification, is not robust to outliers; this may be attributed to the fact that PCA is an L₂ optimization problem due to which grossly corrupted data points may perturb and skew the eigenvectors spanning the maximum variance subspace of the data points significantly.

The Robust PCA (RPCA) problem (Netrapalli et al., 2014) addresses the following question: suppose we are given a data matrix M which is the sum of an unknown low-rank matrix L and an unknown sparse matrix S, can we recover each of the component matrices? RPCA is a widely used technique due to its ability to handle low-rankness, which is commonly observed in various applications such as recommendation systems, visual analytics, and social networks (Vaswani et al., 2018). Recently, RPCA has also been applied to parameter-efficient fine-tuning in the LLM domain (Nikdan et al., 2024).

While several works (Yi et al., 2016; Hsu et al., 2011) analyze the robust decomposition problem, it is shown in (Ne-trapalli et al., 2014) that, under information-theoretically tight assumptions, a simple iterative algorithm based on non-convex alternating projections of appropriate residuals provably yields an ϵ-accurate solution in O (log (1/ϵ)) iterations with an overall computational complexity of O(n²2?log(1/ϵ)) where r is the rank of L. We will use this result, in particular, to derive guarantees for our ranking problem.

### Problem Setup and Solution Approach

### Notation

We first define some notation. We denote the set of all permutations of n LLM responses/items as Sₙ. If not specifically defined, we use lower-case letters for scalars, upper-case letters for global constants, lower-case bold-face letters for vectors and upper-case bold-face letters for matrices; specifically, P denotes a preference matrix. Let Pₙ:={P∈[0, 1]^{n×n}|Pᵢⱼ+Pⱼᵢ=1} denote the set of all pairwise preference matrices over n responses. Let the set of stochastic-transitive matrices be Pₙ^{ST}:={P∈Pₙ|Pᵢⱼ>1/2, Pⱼₖ>1/2⇒Pᵢₖ>1/2}. Let the set preference matrices described by the BTL model be Pₙ^{BTL}:={P∈Pₙ|∃w∈Rⁿ s.t. e^{-wi}/(e^{-wi}+e^{-wj})}. Let ψ: [0, 1] R be a strictly increasing bijective L-Lipschitz function and define the class of low-rank preference matrices with respect to ψ as Pₙ^{LR(ψ,r)}=P∈Pₙ rank ωP≤ r where r∈[n]; when we apply such a transformation to a matrix, it is applied entry-wise. In this paper, we take ψ to be the logit function.

For any matrix M∈R^{n×n}, let the infinity norm be denoted by ∥M∥_{∞}=max_{i, j}|Mᵢⱼ|, the Frobenius norm be denoted by

$${‖ M ‖}_{F} = \sqrt{{\sum }_{i = 1}^{n} {\sum }_{j = 1}^{n} {M}_{ij}^{2}}$$

the spectral norm be denoted by ∥M∥₂=max_{x,y∈R}nx^{T}My. Denoting the indicator function by 1, define the zero norm of a matrix to be the maximum number of non-zero elements in any row/column, i.e.,

$${‖ M ‖}_{0} = max ( {max}_{j} {\sum }_{i = 1}^{n} \text{?} ( {M}_{ij} \neq 0 ) , {max}_{i} {\sum }_{i = 1}^{n} \text{?} ( {M}_{ij} \neq 0 ) ) .$$

Let the Singular Value Decomposition (SVD) of a square matrix be given by M=UΣV^{T} where U, V∈R^{n×r} are orthonormal matrices (whose columns are singular vectors) and Σ∈ [symbol] is the diagonal matrix of singular values. Now, M is said to be μ-incoherent if max

$$( {max}_{i} {‖ {e}_{i}^{T} U ‖}_{2} \cdot {max}_{i} {‖ {e}_{i}^{T} V ‖}_{2} ) \leq μ \sqrt{r / n} and {σ}_{m i n} := {min}_{i} {Σ}_{ii} .$$

denotes the i^{th} basis vector in [symbol] . Also let σₘₐₓ:=maxᵢ

We define the distance between a permutation σ∈Sₙ and a preference matrix P∈Pₙ as:

$$dist ( σ , P ) := {( \begin{matrix}n \\ 2\end{matrix} )}^{- 1} {\sum }_{i < j} \text{?} ( ( {P}_{ij} > 1 / 2 ) ∧ ( σ ( i ) ≻ σ ( j ) ) ) + {( \begin{matrix}n \\ 2\end{matrix} )}^{- 1} {\sum }_{i < j} \text{?} ( ( {P}_{ji} > 1 / 2 ) ∧ ( σ ( j ) ≻ σ ( i ) ) )$$

Note that the above loss function basically is the number of pairs on which the ordering with respect σ and P differ divided by the number of ways to choose two out of n responses. Finally, let Pₘᵢₙ=min_{i≠j} Pᵢⱼ and Δ=min_{i≠j}|ψ (Pᵢⱼ)−ψ(1/2)|.

### Characterization of the Adversary

The following (weak) assumption characterizes the properties of the adversary. We shall see in the next section that it is information-theoretically tight in order to guarantee recovery in the solution approach that we propose. Note that this is a deterministic assumption; in particular, we do not have any distributional assumptions regarding the locations, the signs, or the magnitudes of the corruptions, and hence is very general.

Assumption 1. The (additive) adversarial noise which corrupts a μ-incoherent preference matrix P∈Pₙ^{LR(ψ, r)} is modeled by a skew-symmetric sparse matrix S so that the corrupted preference matrix P^{C} ∈Pₙ is given by P^{C}=P+S. We assume the (deterministic) bounded degree condition that ∥S∥₀≤d<n such d<n/512μ²r where r≤n.

So, why do existing non-robust algorithms not recover the true response ordering in the presence of an adversarial noise source? This question is answered by the following proposition which precisely quantifies how bad a ranking could be when an algorithm uses the corrupted pairwise preference matrix. The key idea is to construct an adversary that intentionally flips true comparison results.

Claim 1 (Upperbound on estimation error). Under Assumption 1 it is possible that dist(\hat{σ}, P^{C})=O(1).

Proof Assume that we are exactly given the entries of the preference matrix as opposed to sampling them. Note that in order to estimate a ranking from a given preference matrix, we still need to use a pairwise ranking procedure. Let \hat{σ}E Sn be the output of any Pairwise Ranking (PR) procedure with respect to an underlying preference matrix Q∈Pₙ.

Procedure 1 RPCA: Robust Principal Component Analysis

Input: M = L [symbol] + S [symbol] , rank r of L [symbol] .
Output: \hat{L}, Ŝ.
1: Solve the following optimization problem using Algorithm 1 of (Netrapalli et al., 2014);
$\{ \hat{L} , \hat{S} \} = arg {min}_{L , S} {‖ M - L - S ‖}_{F}$
s.t. rank(L) ≤ r, ||S||₀ ≤ d
2: return \hat{L}, Ŝ. [symbol]
indicates data missing or illegible when filed

Procedure 2 PR: (γ-approximate) Pairwise Ranking

$Input : Preference matrix M ∈ {ℝ}^{n \times n} ,$
Output: Ranking \hat{σ}.
$1 : Compute ∀ i . {v}_{i} ← {\sum }_{j = 1}^{n} \text{?} ( {M}_{ij} > 1 / 2 ) .$
2: return \hat{σ} ← Sort(v).

For a constant γ>1, \hat{σ} is said to be γ-approximate if dist(\hat{σ}, Q)≤γ min_{σ∈Sn} dist(σ, Q). Define the following distance which measures the fraction of response pairs over which two preference matrices {Q, R}∈Pₙ disagree.

$$dist ( Q , R ) := {( \begin{matrix}n \\ 2\end{matrix} )}^{- 1} {\sum }_{i < j} \text{?} ( ( {Q}_{ij} > 1 / 2 ) ∧ ( {R}_{ij} < 1 / 2 ) ) + {( \begin{matrix}n \\ 2\end{matrix} )}^{- 1} {\sum }_{i < j} \text{?} ( ( {Q}_{ij} < 1 / 2 ) ∧ ( {R}_{ij} > 1 / 2 ) )$$

By Lemma 20 of (Rajkumar and Agarwal, 2016), for Q∈Pₙ^{ST} and R∈Pₙ, we have dist (\hat{σ}, Q)≤(1+γ) dist Q, R. But note that it is possible that dist Q, R=1 as it is easy to construct by R that disagrees with Q in every entry by simply setting R=Q^{T}. Now, we may set Q=P and R=P^{c} for any algorithm that uses Pc for ranking; specifically, for the adversary satisfying Assumption 1, we can see by a direct counting argument that dist

$$( Q , R ) \leq \frac{d ( 2 n - 1 - d )}{n ( n - 1 )}$$

which proves the claim.

### Alignment of LLMs Using Direct Preference Optimization

We utilize Direct Preference Optimization (DPO) (Rafailov et al., 2023) to align LLMs in our experiment to examine the efficacy of our algorithms in solving incomplete and adversarially corrupted preference data problems. DPO is a widely used method for PL, due to its simplicity, stability, performance, and computational efficiency. Essentially, DPO is a loss function that can be expressed as a mathematical equivalent to Reinforcement Learning with Human Feedback (RLHF). Its purpose is to optimize preferences by classifying human preference data without resorting to reward modeling or reinforcement learning.

$${ℒ}_{DPO} ( θ , {y}_{w} , {y}_{l} ) = - log σ ( β log \frac{{π}_{θ} ( {y}_{w} )}{{π}_{ref} ( {y}_{w} )} - β log \frac{{π}_{θ} ( {y}_{l} )}{{π}_{ref} ( {y}_{l} )} ) ,$$

where y_{w} and yₗ represent preferred and dispreferred responses respectively. π_{ref} is the reference policy, and π_{θ} is the new policy.

### Solution Approach

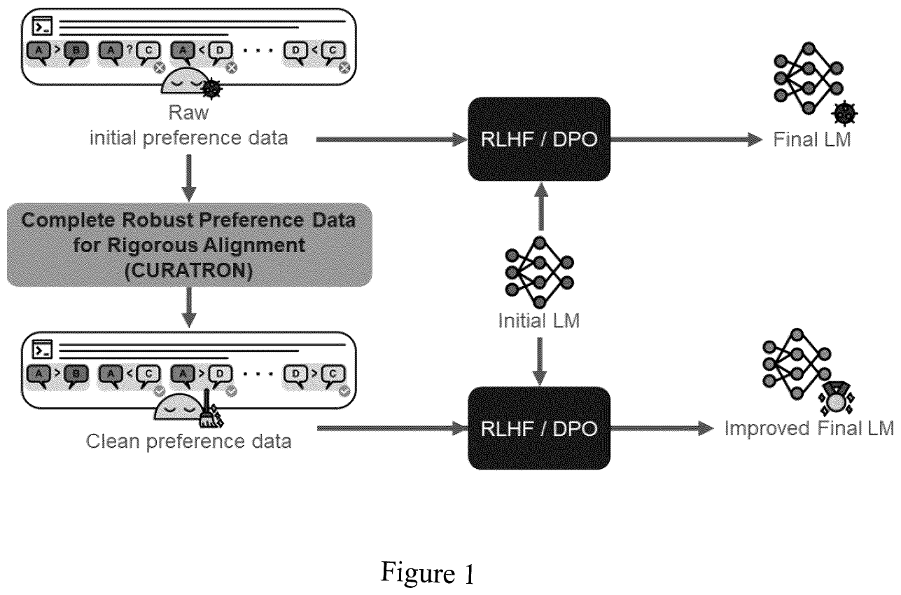

In real-world scenarios, it is common to have missing or corrupted data, especially in large-scale crowdsource data. Our proposed methods aim to take the raw corrupted data as input and output the recovered data that closely resembles the counterfactual original data. This recovered data is then input into the alignment step, as illustrated in FIG. 1.

To achieve this, we first transform the raw preference data into a logit preference matrix space to utilize the low-rank characteristic. Different ranking approaches, such as, pointwise, pairwise, and listwise, can be represented in this logit preference matrix space.

$$ψ ( P ) = log \frac{P}{1 - P} , where P = \frac{{e}^{- {w}_{i}}}{{e}^{- {w}_{i}} + {e}^{{w}_{j}}}$$

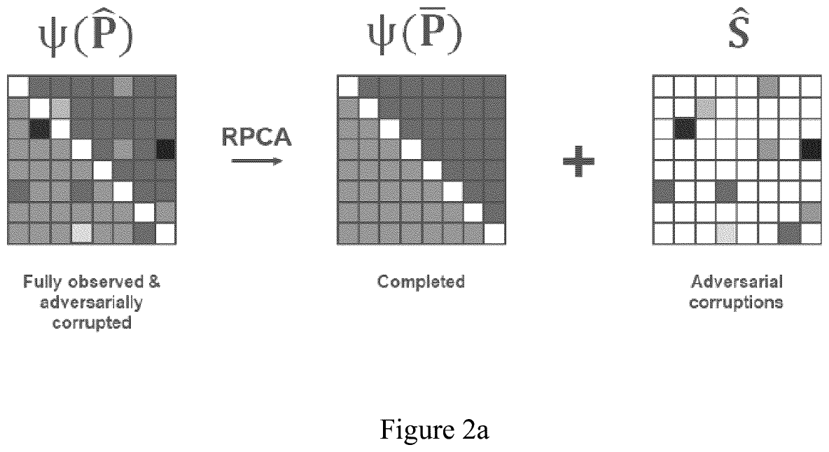

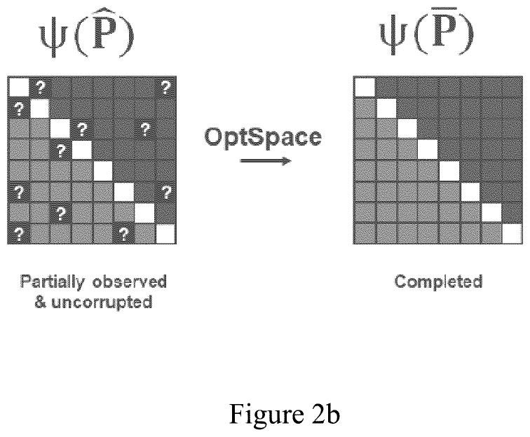

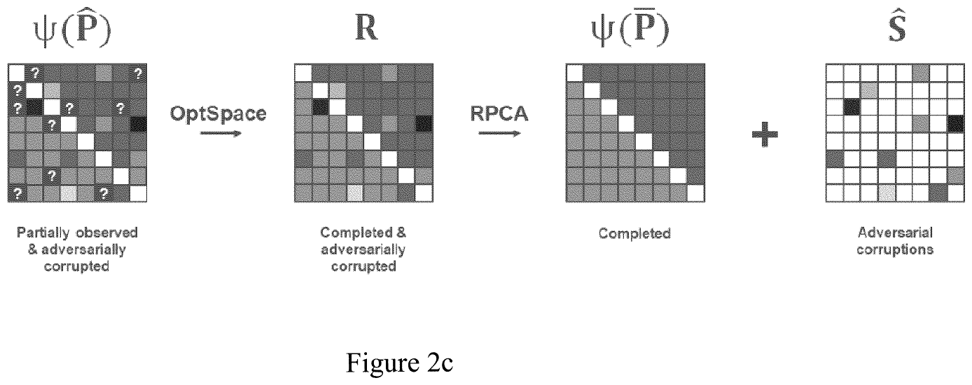

We now identify three scenarios/settings where missing and adversarially corrupted comparisons can affect the ranking of responses and tackle them in detail in subsequent sections.
1. Fully observed and adversarially corrupted setting (FIG. 2a, Section 4): Some instances of the comparison results are adversarially corrupted. This scenario can happen when data quantity is prioritized over data quality in the data collection process, resulting in biased or malicious human feedback. Algorithm 3 RORATRON is proposed to solve this problem.
2. Partially observed and uncorrupted setting (FIG. 2b, Section 5.1): Not all pairs of responses are compared. This scenario can happen when data quality is prioritized over quantity in the data collection process. Observing all possible comparisons can be expensive and challenging, especially when there are many LLM responses to compare. Algorithm 4 CORATRON is proposed to solve this problem.
3. Partially observed and adversarially corrupted setting (FIG. 2c, Section 5.2): Both (1) not all pairs of responses are compared, and (2) some instances of the comparison results are adversarially corrupted. This scenario can happen when data quantity and quality are not met in the data collection process. This scenario will likely happen in a large crowd-sourced environment due to large-scale LLM responses and participants. Algorithm 5 CURATRON is proposed to solve this problem.

### Fully Observed and Adversarially Corrupted Setting

### Algorithm

In this section, we answer Question 4. We present our main algorithm for robust passive ranking from pairwise comparisons in the presence of adversarial noise in Algorithm 3. The input data consist of the set of pairwise comparison results N={(i,j, {y^{k}ᵢⱼ})}, (i, j)∈[n]×[n], k∈[K], y^{k}ᵢⱼ∈{0, 1}. The algorithm assumes the true rank of ψ(P) as an input parameter; specifically, for the BTL model, we set r=2. Algorithm 3 RORATRON calls the following procedures:
1. Robust PCA (Procedure 1): Note that Step 3 of Algorithm 3 uses a matrix low-rank plus sparse decomposition subroutine. To obtain our recovery guarantee, it is sufficient to use the robust PCA problem as a black-box method; for the precise details of this algorithm, we refer the reader to (Netrapalli et al., 2014). In particular, for our analysis, we use the noise-case guarantees in their paper. This is characterized by a (strongly-polynomial) running time of O n²r² log (1/ϵ)) and guarantees ϵ-recovery of the component matrices under the conditions of Assumption 1 and Lemma 3.
2. γ-approximate pairwise ranking procedure (Subroutine 2): Step 4 of Algorithm 3 calls a constant factor approximate ranking procedure. Specifically, we use the Copeland procedure (Copeland, 1951) which has a 5-approximation guarantee (Coppersmith et al., 2006) and involves sorting the responses according to a score of response i given by

$${\sum }_{i = 1}^{n} \text{?} ( {\overline{P}}_{ij} > 1 / 2 ) .$$

### Analysis

We begin with a useful short result followed by the statement and the proof of our main result that, with high probability, we achieve ϵ-accurate ranking in polynomial time using polynomial number of samples, despite the presence of adversarial noise. Precisely, Theorem 1 and Remark 1 address Question 3; Remark 2 addresses Question 1. In this context it is noteworthy that we present the result for LR models which strictly contain the BTL model while being much more general (Rajkumar and Agarwal, 2016); upon proving this result, we specialize it to the classic BTL model as well (Corollary 1).

Lemma 1 (Some properties of the logit function). Let a, b, c∈(0, 1) such that c=a+b. Then, we have,

$$1. ψ ( c ) = ψ ( a ) + ψ ( a + b ) + ψ ( 1 - a )$$

$$2. ψ ( a ) + ψ ( 1 - a ) = 0 .$$

Proof. Both follow by using the definition of the logit function that ψ(a)=log(a/(1−a)) and using the property that log(ab)=log(a)+log(b).

Algorithm 3 RORATRON: Robust Preference Data for Rigorous Alignment

$Input : Comparison dataset \text{?} = \{ ( i , j , \{ {y}_{ij}^{k} \} ) \} , true rank r .$
Output: Ranking of n responses, \hat{σ} ∈ [symbol] .
1: Estimate entries of \hat{P} for i ≤ j as:
${\hat{P}}_{ij} = \{ \begin{matrix}\frac{1}{K} {\sum }_{k = 1}^{K} {y}_{ij}^{k} & if i < j \\ 1 / 2 & if i = j\end{matrix}$
2: Set \hat{P}ᵢⱼ = 1 − \hat{P}ⱼᵢ for all i > j.
3: Perform robust PCA: {ψ(P̅), Ŝ} + RPCA(ψ(\hat{P}), r).
4: Using a pairwise ranking procedure after taking the inverse transform: \hat{σ} ← PR(P̅).
S: return \hat{σ}.

Theorem 1 (Provably good estimation of ranking in LR models in the presence of adversarial noise). Let P∈PnLR(ψ, r) be the true preference matrix according to which the pairwise comparison dataset [symbol] ={(i, j, {ykij})} is generated for all responses pairs (i, j) such that k∈[K]. Let P be the empirical preference matrix computed using [symbol] . Let S∈[0, 1]^{n×n} be the adversarial matrix that additively corrupts P. Let ψ be L-Lipschitz in [Pmin/2, 1−Pmin/2] and ψ (P) be μ-incoherent. Let each pair be compared independently K≥3 16384μ2(1+γ) L2 n2 log (n)/ϵ Δ times where Δ=mini≠j ψ Pi j ψ 1 2. Then, with probability at least 1-1 n, Algorithm 3 returns an estimated permutation \hat{σ} such that dist(\hat{σ}, P)≤Σ.

Remark 2 (Identifying adversarially corrupted pairwise comparisons). From Step 3 of Algorithm 3, using Theorem 2 of Netrapalli et al., 2014), we also have Supp S Supp S and thus we can identify the corrupted pairwise comparison results.

Remark 3 (Missing data versus adversarially corrupted data). Note that the adversarial sparse noise we consider subsumes the setting when comparison results for certain pairs are missing as in (Rajkumar and Agarwal, 2016) and hence directly applies in that situation. Moreover, since the support and magnitude of the corrupted entries of the preference matrix are unknown, the problem considered in this paper is harder; consequently, our sample complexity is O(n²) as opposed to O (n poly log n) in their work.

Proof Let \tilde{P}ᵢⱼ be the empirical probability estimate of Pᵢⱼ. Note that we compute

$${\tilde{P}}_{ij} = \frac{1}{K} {\sum }_{k = 1}^{K} {y}_{\vert ij}^{k}$$

from the given pairwise comparison dataset, [symbol] ={(i, j {y^{k}ᵢⱼ})}. Now, \hat{p}=\tilde{P}+S. By Lemma 1, we may write the adversarially corrupted empirical probability estimate as ψ(\hat{p}=ψ \tilde{P} Ŝ where Ŝ=ψ C+S+ψ (1−P). We have ψ \tilde{P}=ψ P+Ñ where Ñ=ψ (\tilde{P})−ψ(P). Now, this noise, Ñ, is purely due to finite-sample effects which can be controlled (using concentration arguments given in the inequality ξ₃ below) by driving it down to as small a value as we want by ensuring large enough number of comparisons for each pair. Note that we input ψ (\hat{p})=ψ (P)+Ŝ+Ñ to Subroutine 1 and obtain ψ (P-bar) as the output in Step 3 of Algorithm 3. Hence, using Theorem 2 from (Netrapalli et al., 2014), if ∥Ñ∥_{∞}≤σmin(ψ (P))/100n, we have,

$${‖ ψ ( \overline{P} ) - ψ ( P ) ‖}_{F} \leq {ϵ}^{′} + 2 {μ}^{2} r ( 7 {‖ \tilde{N} ‖}_{2} + \frac{8 n}{r} {‖ \tilde{N} ‖}_{∞} )$$

after T≥10 log(3μ²rσ₁/ϵ′) iterations associated with Step 1 of Subroutine 1. Next, we have, with probability at least 1−1/n³,

$${‖ ψ ( \overline{P} ) - ψ ( P ) ‖}_{F} \leq {ϵ}^{′} + 2 {μ}^{2} r ( 7 {‖ \tilde{N} ‖}_{2} + \frac{8 n}{r} {‖ \tilde{N} ‖}_{∞} ) {\leq }^{{ξ}_{1}} {ϵ}^{′} + 32 {μ}^{2} n {‖ \tilde{N} ‖}_{⌢} {\leq }^{{ξ}_{2}} {ϵ}^{′} + 32 {μ}^{2} n τ {\leq }^{{ξ}_{3}} \sqrt[n]{\frac{ϵ}{1 + γ}} \frac{Δ}{2}$$

where ξ₁ follows by using r≤n and ∥Ñ∥_{∞}≤∥Ñ∥₂, ξ₂ follows by substituting for Ñ from Lemma 2 with

$$K \geq \frac{{L}^{2} {n}^{2} {log}^{2} n}{\text{?}} ,$$

$$\text{?} \text{indicates text missing or illegible when filed}$$

and ξ₃ is obtained using:

$${ϵ}^{′} = n \sqrt{\frac{ϵ}{1 + γ}} \frac{Δ}{4} , τ = min ( {σ}_{m i n} ( ψ ( P ) ) / 100 , \sqrt{\frac{ϵ}{1 + γ}} \frac{Δ}{128 {μ}^{2}} ) .$$

Then using similar arguments as proof of Theorem 13 in (Rajkumar and Agarwal, 2016), we obtain our result.

Lemma 2 (Concentration of sampling noise). Under the conditions of Theorem 1, let each response pair be compared such that the number of comparisons per response pair is

$$K \geq \frac{{L}^{2} {n}^{2} log ( n )}{{τ}^{2}} ;$$

with probability at least 1−1/n³, ∥Ñ∥₂≤τ.

Proof. Let L be the Lipschitz constant of ψ and set

$$K \geq \frac{{L}^{2} {n}^{2} log ( n )}{{τ}^{2}} .$$

Using the inequality that ∥Ñ∥₂≤n ∥Ñ∥_{∞},

$$Pr ( {‖ \tilde{N} ‖}_{2} \geq τ ) \leq Pr ( {‖ \tilde{N} ‖}_{∞} \geq \frac{τ}{n} ) = Pr ( ∃ ( i , j ) : \vert ψ ( {\hat{P}}_{ij} ) - ψ ( {P}_{ij} ) \vert \geq \frac{τ}{n} ) \leq {\sum }_{i , j} Pr ( \vert ψ ( {\hat{P}}_{ij} ) - ψ ( {P}_{ij} ) \vert \geq \frac{τ}{n} ) \leq {\sum }_{i , j} Pr ( \vert {\hat{P}}_{ij} - {P}_{ij} \vert \geq \frac{τ}{nL} ) \leq \frac{1}{{n}^{3}}$$

Next, for completeness, we recall the following lemma (proved in Theorem 8 and Lemma 14 of (Rajkumar and Agarwal, 2016)) which characterizes the incoherence constant μ of P∈(Pn^{LR(ψ,2)}∩Pₙ^{ST}) in Assumption 1.

Lemma 3 (Incoherence of BTL and LR models). We have P∈(Pn^{LR(ψ,2)} ∩Pₙ^{ST}) if and only if ψ(P)=uv^{T}−vu^{T} for u∈Rⁿ and v∈Rⁿ where u^{T}v=0. Moreover, ψ(P) is μ-incoherent where

$$μ = \sqrt{\frac{n}{2}} {( \frac{{u}_{m ax}^{2}}{{u}_{m i n}^{2}} + \frac{{v}_{m ax}^{2}}{{v}_{m ax}^{2}} )}^{1 / 2}$$

where uₘᵢₙ=minᵢ|uᵢ|, uₘₐₓ=maxᵢ|uᵢ|, vₘᵢₙ=minᵢ|vᵢ| and vₘₐₓ=minᵢ|vᵢ|. We also have Pn^{BTL)}⊂(Pn^{LR ψ2)}∩Pₙ^{ST}) since we may set u=1 where 1 is the all-ones vector and v=w where w is the BTL parameter vector. In this case, we may rewrite

$$μ = \sqrt{\frac{n}{2}} ( 1 + \frac{{( {w}_{m ax} - \overline{w} )}^{2}}{{( {w}_{m i n} - \overline{w} )}^{2}} )$$

$${}^{w} \overline{w} = \frac{1}{n} {\sum }_{i = 1}^{n} {w}_{i} .$$

The following corollary makes precise our claim that up to O(n²) response pairs may be subject to adversarial corruption but our RORATRON algorithm still recovers a good ranking.

Corollary 1 (Recovery result for BTL model). Consider P∈Pₙ^{BTL}. Using Assumption 1, let the adversarial matrix be S∈[0, 1]^{n×n} satisfying ∥S∥₀≤n/1024μ² where μ is characterized as in Lemma 3. Then, with probability 1−1/n³, the output of Algorithm 3 with input \hat{p} computed using N={(i,j, {y^{k}})} satisfies and r=2, dist(\hat{σ}, P)≤ϵ.

### Partially Observed Uncorrupted and Adversarially Corrupted Settings

### Partially Observed and Uncorrupted Setting

In the case when we are confident that the data are collected faithfully but we do not have the complete data to work with, we can use the ‘OptSpace’ matrix completion algorithm of (Keshavan et al., 2010) by itself to generate the full preference matrix from the incomplete one, as presented in Algorithm 4 CORATRON. We show in Experiment 7.3 below that we can still complete the full matrix with minimal error in such a setting with extremely missing data.

Algorithm 4 CORATRON: Complete Preference Data for Rigorous Alignment
$Input : Comparison dataset \text{?} = \{ ( i , j , \{ {y}_{ij}^{k} \} ) \} , true rank r .$
Output: Ranking of n responses, \hat{σ} & [symbol] .
1: Estimate entries of \hat{P} for i ≤ j as:
${\hat{P}}_{ij} = \{ \begin{matrix}\frac{1}{K} {\sum }_{k = 1}^{K} {y}_{ij}^{k} & if i < j and ( i , j ) ∈ Ω \\ 1 / 2 & if i = j and ( i , j ) ∈ Ω \\ 1 / 2 & if ( i , j ) ∉ Ω\end{matrix}$
2: Set \hat{P}ᵢⱼ = 1 − \hat{P}ⱼᵢ for all i > j.
3: Set R ← OptSpace(ψ(\hat{P})_{Ω}).
4: Using a pairwise ranking procedure after taking the inverse transform: \hat{σ} ← PR(R).
5: return \hat{σ}.

Algorithm 5 CURATRON: Complete Robust Preference Data for Rigorous Alignment

$Input : Comparison dataset \text{?} = \{ ( i , j , \{ {y}_{ij}^{k} \} ) \} , true rank r .$
Output: Ranking of n responses, \hat{σ} ∈ [symbol] .
1: Estimate entries of \hat{P} for i ≤ j as:
${\hat{P}}_{ij} = \{ \begin{matrix}\frac{1}{K} {\sum }_{k = 1}^{K} {y}_{ij}^{k} & if i < j and ( i , j ) ∈ Ω \\ 1 / 2 & if i = j and ( i , j ) ∈ Ω \\ 1 / 2 & if ( i , j ) ∉ Ω\end{matrix}$
2: Set \hat{P}ᵢⱼ = 1 − \hat{P}ⱼᵢ for all i > j.
3: Set R ← OptSpace(ψ(\hat{P})_{Ω}).
4: Use a robust PCA procedure: ψ(P̅) ← RPCA(R).
5: Using a pairwise ranking procedure after taking the inverse transform: \hat{σ} ← PR(P̅).
6: return \hat{σ}.

### Partially Observed and Adversarially Corrupted Setting

In this subsection, we consider the partially observed and adversarially corrupted comparison results setting. Both factors can be modeled in a unified manner by setting the corresponding missing entries of the preference matrix to zero (or a specific constant to account for numerical stability). We present our robust ranking algorithm for this setting in Algorithm 5 CURATRON—this essentially involves using OptSpace (Keshavan et al., 2010) followed by using the robust PCA algorithm of (Netrapalli et al., 2014) as sub-routines. We note at this point that, while (Niranjan and Rajkumar, 2017) work considers the incomplete data case, it leverages extra information provided in the form of side information (specifically, noiseless and complete item-related features) to derive recovery guarantees. Also, their algorithm is still unable to handle the presence of pairwise comparisons corrupted in an adversarial manner, which is explored in the (Niranjan et al., 2017) work. We now derive the recovery guarantees as follows.

Theorem 2 (Provably good estimation of ranking in BTL model in the presence of adversarial noise as well as missing data). Consider similar notations as in Theorem 1 but let P∈Pₙ^{BTL} Let Ω⊆[n]×[n] be a set of compared response pairs. Assume Ω is drawn uniformly

$$\frac{\vert log ( n )}{{C}_{Δ} n}$$

from all subsets of [n]×[n] of size |Ω| such that |Ω|≥C″n log(n) and let the sparse noise satisfy ∥S∥_{∞}≤Δw where Δw:=min_{i,j}|wᵢ−wⱼ|. Let the number of comparisons per pair be K≥cn⁴/Δ_{w}. Then with probability at least 1−2/n³. Algorithm 5 returns a ranking that satisfies dist(\hat{σ}, P)≤Σ.

Remark 4 (Robust Estimation of BTL Model in the Partially Observed Case). For the BTL model, Theorem 2 says O n log n pairs suffice to estimate the BTL model, which matches bounds from (Rajkumar and Agarwal, 2016). Further, even in this incomplete comparison data case, we are able to tolerate uniformly random additive sparse noise with its maximum absolute entry scaling as the order of the BTL ‘score-gap’ divided by the number of responses up to logarithmic factors, ie, Ō (Δ_{w}/n).

Proof From Lemma 3, —we have ψ P=1w^{T}−w1^{T} for the BTL model where ψ is the logit function. Clearly, in this case, ψ (P) is a real skew-symmetric matrix of rank r=2. Since it is skew-symmetric, its eigenvalues, which are the roots of its characteristic polynomial, are of the form ±λi for some λ∈R and i=\sqrt{−1}, and hence, σₘᵢₙ(ψ (P))=σₘₐₓ(ψ (P)), i.e., the condition number of ψ (P), κ=1. Now, we recall the spectral-lower bound from Corollary 2 of (Horne, 1997)

$${σ}_{m i n} ( ψ ( P ) ) \geq \frac{{‖ ψ ( P ) ‖}_{F}}{\sqrt{r ( r - 1 )}} \geq \sqrt{\frac{n ( n - 1 )}{2}} {Δ}_{w} \qquad ( 1 )$$

where Δw=min_{i,j}|wᵢ−wⱼ|.

Let Ω⊆[n]×[n] be a subset of all the response pairs with comparison results among which some might be corrupted by sparse noise, i.e., ψ(\hat{p}_{Ω})=ψ(P_{Ω})+−Ś_{Ω}+Ñ_{Ω}. Let T:=Ś_{Ω}+Ñ_{Ω}. From Theorem 1.2 of (Keshavan et al., 2010), we have 1/n

$${‖ ψ ( \hat{p} ) - ψ ( P ) ‖}_{F} = 1 / n {‖ T + M ‖}_{F} \leq C {κ}^{2} \frac{n \sqrt{r}}{\vert Ω \vert} {‖ T ‖}_{2}$$

where M is the noise matrix after obtaining the completed matrix ω\hat{p} from ω\hat{p}_{Ω} using OptSpace. Using triangle inequality and noting that Ω≥C′n log(n), the noise may be bounded as:

$${‖ {\tilde{N}}_{Ω} + M ‖}_{∞} \leq {‖ {\tilde{N}}_{Ω} + M ‖}_{F} \leq {‖ T ‖}_{2} \frac{\sqrt{2} {Cn}^{2}}{\vert Ω \vert} + {‖ {\tilde{S}}_{Ω} ‖}_{F} {\leq }^{{ζ}_{1}} {C}^{′} \frac{n}{log ( n )} {‖ {\tilde{S}}_{Ω} ‖}_{2} \qquad ( 2 )$$

where C, C′ and C″ are constants and ζ₁ is obtained by using the triangle inequality that ∥T∥₂≤∥\tilde{S}_{Ω}∥_{F}≤\sqrt{n}∥\tilde{S}_{Ω}∥₂ ∥S_{Ω}∥₂+∥Ñ_{Ω}∥₂, followed by setting K≥cn⁴/Δ_{w} for constant c and finally using
Then, combining Equations 2 and 1, we have if:

$$\frac{log ( n )}{{C}_{Δ} n \vert} {Δ}_{w} \geq {‖ {\tilde{S}}_{Ω} ‖}_{2} = {‖ ψ ( \hat{P} ) - ψ ( \tilde{P} ) ‖}_{2} \geq {‖ ψ ( \hat{P} ) - ψ ( \tilde{P} ) ‖}_{∞} \geq L {‖ \hat{P} - \tilde{P} ‖}_{∞} \geq {‖ S ‖}_{∞}$$

where C_{Δ} is a global constant and using Lemma 2, then we have the guarantee (along similar lines as that of Theorem 1 that Algorithm 5 returns an estimated permutation which satisfies dist(\hat{σ}, P)≤ϵ.

### Generalization to Other Ranking Models

Related to the BTL model are many other binary choice models (Fishburn, 1973) such as the Thurstonian model (Thurstone, 1927). In such models, the preference matrix has been shown to be low-rank under appropriate choices of ψ, for instance, for the Thurstonian models, the probit function turns out to be the right choice. For further details, we refer the reader to the work of (Rajkumar and Agarwal, 2016).

Let a, b, c∈(0, 1) such that c=a+b. Then, for any general non-linear L-Lipschitz function, we write ψ(c)=ψ(a+b)=ψ(a)+ψ(a+b)−ψ(a). The error may be lower bounded by |ψ(a+b)−ψ(a)|≥Lb. Thus, for any adversarial model wherein we have P^{c}=P+S, we have:

$$ψ ( {P}^{c} ) = ψ ( P ) + ( ψ ( P + S ) - ψ ( P ) ) = ψ ( P ) + \tilde{S}$$

where Ś is also a deterministic sparse corruption matrix with the absolute value of-the non-zero entries lower bounded by L. min_{i,j}Sᵢⱼ. With the appropriate ψ, ψ(P) will be a low-rank matrix and hence Algorithm 3 and the associated recovery guarantee of Theorem 1 holds.

### EXAMPLES

The present invention is further illustrated and supported by the following examples. However, these examples should in no way be considered to further limit the scope of the invention. On the contrary, one having ordinary skill in the art would readily understand that there are other embodiments, modifications, and equivalents of the present invention without departing from the spirit of the present invention and/or the scope of the appended claims.

In this section, we answer Question 5. We now perform simulations and experiments with LLM in order to understand the performance of our robust ranking approach in practice in both general and LLM preference dataset settings.

### Evaluation Criterion

We use several evaluations to assess our proposed methods' effectiveness against unobserved and adversarial corrupted comparisons.

### Normalized Frobenius Error

First, to measure the relative error between two preference matrices in_terms of their elements' magnitudes, we use the normalized Frobenius error (NFE). NFE between two matrices P and P-bar is defined as:

$$NFE ( P , \overline{P} ) = \frac{{‖ P - \overline{P} ‖}_{Fro}}{{‖ P ‖}_{Fro}}$$

where the Frobenius norm, denoted as ∥A∥_{Fro}, for a matrix A is calculated by:

$${‖ A ‖}_{Fro} = \sqrt{{\sum }_{i = 1}^{n} {\sum }_{j = 1}^{n} {\vert {a}_{ij} \vert}^{2}}$$

In this formula, aᵢⱼ represents the element of the matrix A in the ith row and jth column. The Frobenius norm is the square root of the sum of the absolute squares of all elements in the matrix. Thus, the numerator ∥P−P-bar∥_{Fro} calculates the Frobenius norm of the difference between the original and reconstructed matrices, and the denominator ∥P∥_{Fro} calculates the Frobenius norm of the original matrix. The ratio provides a measure of the relative error normalized by the magnitude of the original matrix.

### Correlation Coefficient

Second, we compute the correlation coefficient for corresponding elements in these matrices to assess the similarity between the original matrix P and the reconstructed matrix P. The correlation coefficient, denoted as corr, between the elements of these two matrices can be defined as:

$$corr ( P , \overline{P} ) = \frac{{\sum }_{i = 1}^{n} ( {P}_{i} - 〈 P 〉 ) ( {P}_{i} - 〈 P 〉 )}{\sqrt{{\sum }_{i = 1}^{n} {( {P}_{i} - 〈 P 〉 )}^{2}} \sqrt{{\sum }_{i = 1}^{n} {( {\overline{P}}_{i} - 〈 \overline{P} 〉 )}^{2}}} ,$$

where P and (P̅) denote the mean values of the elements within the P and (P̅) matrices, respectively. n represents the total number of elements in each matrix.

This formula quantifies the linear relationship between the matrices' elements. A correlation coefficient close to 1 indicates a strong positive linear relationship, whereas a value close to −1 suggests a strong negative linear relationship. A coefficient around 0 implies no linear relationship.

### Ranking Distance

Third, for ease of reference, we rewrite the dist(\hat{σ}, P) formula, which evaluates the distance between rankings obtained by corrupted and recovered matrices, previously defined in the Notation section, above:

$$dist ( \hat{σ} , P ) := {( \begin{matrix}n \\ 2\end{matrix} )}^{- 1} {\sum }_{i < j} 𝕝 ( ( {P}_{ij} > 1 / 2 ) ∧ ( \hat{σ} ( i ) ≻ \hat{σ} ( j ) ) ) + {( \begin{matrix}n \\ 2\end{matrix} )}^{- 1} {\sum }_{i < j} 𝕝 ( ( {P}_{ji} > 1 / 2 ) ∧ ( \hat{σ} ( j ) ≻ \hat{σ} ( i ) ) ) ,$$

where \hat{σ} is the global ranking after applying ranking procedure with P̅.

### Performance of Robust Ranking in General Setting

First, we begin with the BTL model. We generate synthetic pairwise comparison data and also adversarial sparse matrix as follows. We generate the entries of the BTL parameter vector w from N (0, v²) followed by generating the ground truth preference matrix from with y^{k}ᵢⱼ is sampled for all response pairs (i, j) for a fixed K. The adversarial sparse matrix S is generated as a skew-symmetric matrix where each entry is non-zero independently with probability d/n followed by generating a value for an entry from U(5, 10) and then setting the sign to be positive with probability 1/2; this corruption matrix is then added to the ψ(P) to give ψ(P^{c}) which is then input to our algorithm; the same P^{c} is used for the other algorithms as well.

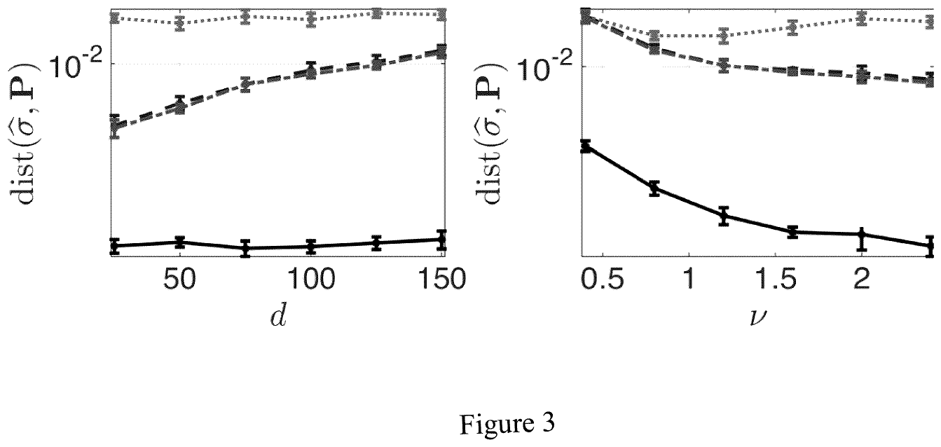

We take the number of responses to be n=500. In plots in FIG. 3, we compare the performance of our RORATRON approach using Algorithm 3 against well-known ranking algorithms, such as Rank Centrality (RC) (Negahban et al., 2012), Maximum Likelihood (ML) and Borda Count (BC) (Jiang et al., 2011), with special attention to robustness to the noise model that we consider in this paper. We vary two parameters, namely, v, the spread of the BTL scores, and a the density of the adversarial corruption matrix. All our results averaged over five runs. We observe that our algorithm maintains low recovery error in spite of increasing the problem hardness, thus outperforming previous approaches in all cases.

### Performance of Robust Ranking in LLM Preference Dataset

In this illustrative experiment, from the MT-Bench dataset (Zheng et al., 2023), we collect the data of the first prompt “Compose an engaging travel blog post about a recent trip to Hawaii, highlighting cultural experiences and must-see attractions” and its six responses from GPT-3.5, GPT-4 (OpenAI et al., 2023), Claude-v1 (Anthropic, 2023), Vicuna-13B (Chiang et al., 2023), Alpaca-13B (Taori et al., 2023), and LLaMA-13B (Touvron et al., 2023a). Additionally, we generated nine responses to the same prompt using Llama-2-70B-chat-hf (Touvron et al., 2023b), Falcon-180B-chat Almazrouei et al. (2023), Openchat-3.5 (Wang et al., 2023), Mixtral-8×7B-Instruct-v0.1 (Jiang et al., 2024), Mistral-7B-Instruct-v0.2 (Jiang et al., 2023a), Gemini-pro (Gemini et al., 2023), Dolphin-2.2.1-mistral-7B (Hartford, 2023), Solar-10.7B-instruct-v1.0 (Kim et al., 2023), Yi-34B-chat (01.ai, 2023) from Hugging Face's HuggingChat (Hugging Face, 2023) and LMSYS's Chatbot Arena (Zheng et al., 2023). We have n=15 responses.

Next, we rank the responses using OpenAI's GPT-4 Turbo GPT-4-1106-preview (OpenAI et al., 2023). This ranking helps us create the BTL parameter vector w. We then sort this vector descendingly for visually accessible when building the corresponding preference matrix P∈R^{n×n}. With n/2 comparisons in P, we randomly remove entries based on a specified deletion probability parameter, dp, to simulate unobserved comparisons. We then create an adversarial skew-symmetric sparse matrix, S, using the given matrix P and an adversarial corruption probability parameter ap. When corruption is applied, it involves randomly selecting a value from U(5, −5) and then adding to the P to give P^{c} which is then become the input of our algorithm. It's important to note that P is a skew-symmetric matrix, any corruption must be applied to both ij and ji values.

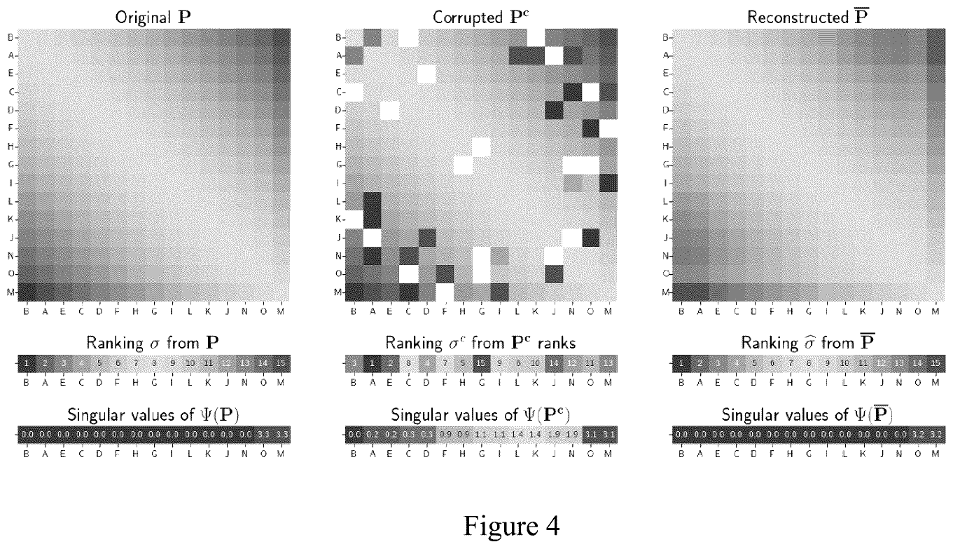

Our experiment results visualized in FIG. 4 show that dp=10% and da=10% can significantly affect the ranking of different models and the rank of the matrix when performing logit link transformation. The ranking can get altered quite badly when compared to the original matrix. Also, the logit link transformation of the corrupted matrix is high-rank which indicates that there are noises in the matrix. By using CURATRON to impute the missing comparisons and filter out the noisy sparse matrix, we successfully reconstruct the original matrix, which is low-rank when in logit link transformed form. As a result, we obtain the correct ranking. We also obtain noisy comparisons that can be used to identify responders with malicious intent and prevent them from continuing to alter results.

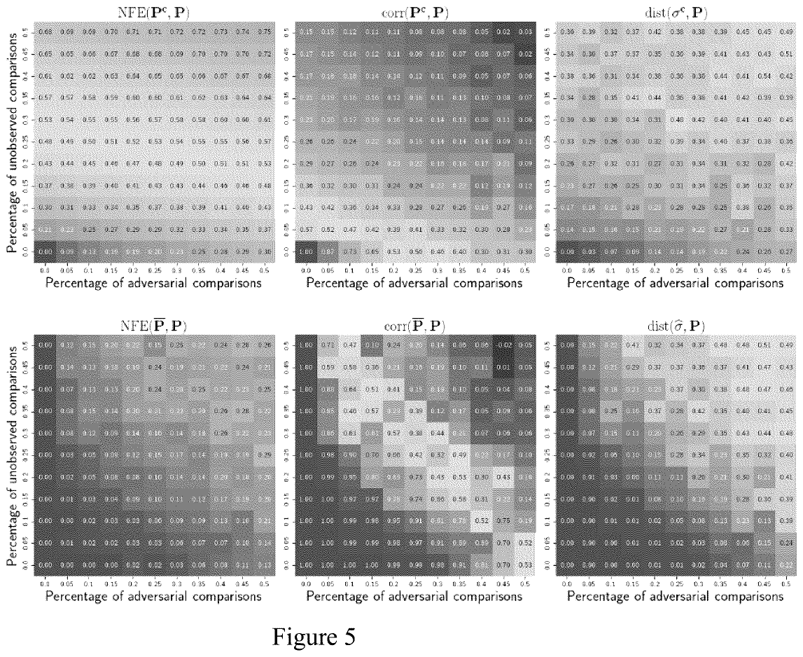

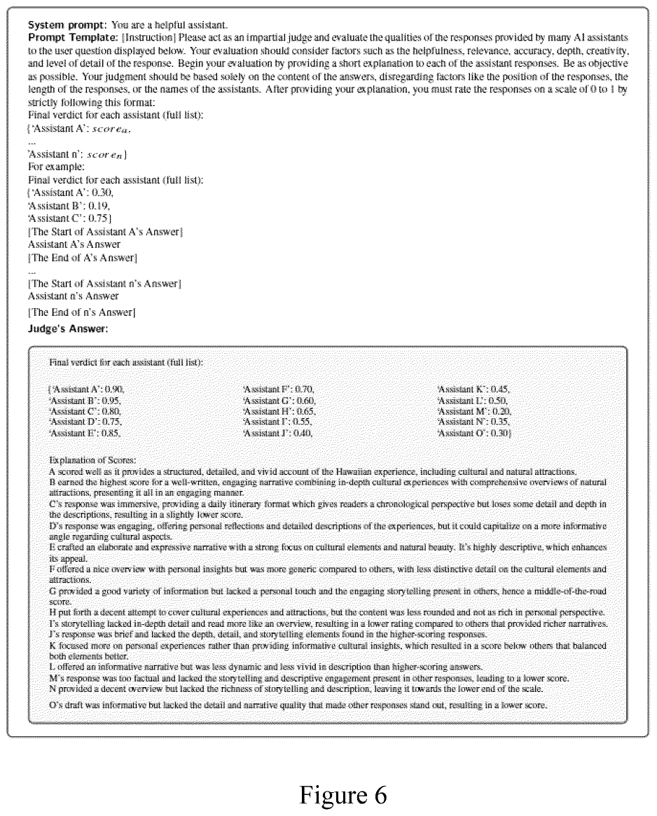

We now examine how our algorithm performs across different levels of unobserved and adversarially corrupted comparisons. In the plots shown in FIG. 5, we compare the performance of our approach by varying two parameters, dp and ap. We use NFE, correlation, and ranking distance as defined earlier (above). Our results are averaged over 5 runs. When there is no adversarial noise, we can recover the original P with no NFE and perfect correlation and ranking, even if 50% of the comparison data was missing. This suggests that we may not need to collect all comparisons from humans to obtain the entire data. We observe that, with n=15, we only need to obtain about 50 55% of the 105 comparisons and fill in the rest with our algorithm to achieve a strict 0% NFE, perfect correlation, and ranking. On the other hand, when missing data is absent, our algorithm performs well with NFE of approximately 6%, even when 35% of the comparison data is adversarially corrupted. When both adversarial noise and missing data are present, we can achieve a low NFE of around 4% when both 15% of the comparison data is missing and 15% of adversarially corrupted comparisons (30% in total) affect P.

### Preference Dataset Recovery and its Effect on LLM Performance

Our goal in this experiment is to assess the effectiveness of our proposed algorithms in reducing corruption in LLM Preference datasets. To achieve this, we design our experiment in the following manner. We utilize the pre-generated responses from 34 models that prioritize the helpfulness objective as the preference dataset available on MT-Bench. We transform this dataset into a pairwise comparison format, where we discard tied comparisons. This transformed dataset is called the original set. We then intentionally corrupt 20% of the data from the original set, which results in a corrupted set. We then apply our algorithm to this corrupted set, which results in a recovered set. Finally, we fine-tune three models from the pretrained OpenHermes-2.5-Mistral-7B (Teknium1, 2023) with these three datasets using DPO.

We use the AlpacaEval benchmark (Li et al., 2023) to evaluate our models, which prioritizes measuring helpfulness. Our DPO-tuned LLM models answer 805 questions on various topics based on the AlpacaEval instructions. To evaluate our models, we compare their responses to the baseline responses generated by a GPT-4 Turbo model, using a referee GPT-4 Turbo model (OpenAI et al., 2023). We use the discrete non-loss rate as our evaluation metric, which is

$$Non - Loss Rate = ( \frac{Wins + Draws}{Total Matches} ) \times 100 \%$$

calculated using the formula:

After comparing the data overlap of three datasets, we found that the recovered dataset has a 96.65% overlap with the original dataset, while the corrupted dataset only overlaps about 68.22% with the original datasets. Our algorithm helped us reduce the size of the recovered dataset by 27.8% (from 44,877 comparisons to 32,391 comparisons), which suggests that our algorithm is sufficient in recovering the original dataset (31,376 comparisons). We also observed that the training losses of the original and recovered datasets were about 10% lower on average than the corrupted dataset. Based on these insights, we expect similar performance in finetuning using the original and recovered datasets. Notably, the corrupted model achieved a non-loss rate of 9.57% against GPT-4 Turbo (OpenAI et al., 2023), while the original model achieved 9.81% and the recovered model achieved 10.06%.

TABLE 1

| | Model | | | |
|---|---|---|---|---|
| | OpenHermes-2.5-Mistral-7B | | | |
| | (Teknium1, 2023) DPO Finetuning | | | |
| | | Overlap | Average | AlpacaEval |
| | Dataset | with the | training | non-loss |
| Dataset type | size | original set | loss | rate |
| Original (baseline) set | 31376 | 100% | 0.4600 | 9.81% |
| Corrupted set | 44877 | 68.22% | 0.5592 | 9.57% |
| Recovered set | 32391 | 96.65% | 0.4638 | 10.06% |

Comparison of DPO finetuned models on three datasets: baseline, corrupted, and recovered MT-Bench datasets (Zheng et al., 2023). Higher values are better for the overlap with the original set and non-loss rate; whereas, for training loss, lower values are better. Being closer to the original dataset size is better in terms of dataset size.

### CONCLUSION

Our study examines how missing information, and distorted feedback can impact LLMs, potentially compromising their performance in terms of alignment with human values. We have proposed a robust algorithm for provably correct and efficient ranking responses in the BTL, LR, and general binary choice models. This robust ranking data is then input in the PL step. Further, we also handled the partially observed setting, wherein only some response pairs are compared, by integrating matrix completion techniques into our robust learning algorithm. In all cases, we provided statistical and computational guarantees using novel techniques. Through our comprehensive analysis, we hope to contribute to the ongoing discussion on AI safety by helping to create and scale LLMs/AGI models that align with human values and expectations. Some future research directions include tightening the recovery results for partially observed settings under weaker conditions (possibly using noisy-case extensions of (Yi et al., 2016)), exploring other notions of adversarial noise, and understanding the minimax optimal rates for ranking estimators under various noise models. We also plan to study the parametric non-active pairwise ranking setting, studying lower bounds and practical algorithms in the active setting similar to (Heckel et al., 2016). Furthermore, it would be interesting to investigate whether we can extend this approach to solve the entity corruption problem in retrieval models, as shown in (Naresh et al., 2022). Another research direction could be defining an alignment framework that expands DPO to various objective functions based on Rank Centrality (Negahban et al., 2017). Finally, we aim to examine the relationship between robust PL and model capacity, as this can shed light on the trade-offs between model complexity and generalization performance.

The following paragraphs enumerated consecutively from 1 through 22 provide for various additional aspects of the present invention. In one embodiment, in a first paragraph:

1. A computer-implemented system to train alignment of preference data of large language models (LLM) in an artificial intelligence agent, the method comprising:
obtaining raw data;
optionally, when the data is fully observed and adversarially corrupted the data is processed by algorithm 3 (RORATRON) to provide an estimate of entries of P-hat for i≤j to provide a ranking of responses data; where the ranking of response data is processed by an robust principal component analysis (RPCA) algorithm to provide a completed dataset wherein the completed dataset is processed by algorithm 2 (procedure 2) to provide a pairwise ranking of the data comprising a revised PL dataset; and
optionally, when the data is partially observed and uncorrupted the raw data is processed by an OptSpace algorithm (algorithm 4) (CORATRON) to provide a completed dataset, wherein the completed dataset is processed by algorithm 2 (procedure 2) to provide a pairwise ranking dataset comprising a revised PL dataset; and
optionally, when the data is partially observed and adversarially corrupted the raw data is processed by an OptSpace algorithm (algorithm 5) (CURATRON) to provide recovered dataset;
wherein the recovered dataset is processed by a robust principal component analysis (RPCA) algorithm to provide a completed dataset; and
wherein the completed dataset is processed by an algorithm 2 (procedure 2 to) provide a pairwise ranking of the data comprising a revised PL dataset;
wherein a large language model (LLM) uses the revised PL dataset from the algorithms 3, 4, or 5 to align the LLM with user preferences.

2. The system of paragraph 1, wherein direct preference optimization (DPO) is used to align LLMs with the revised data.

3. The system of any of paragraphs 1-2, wherein the RPCA is procedure 1.

4. The system of any of paragraphs 1-3, wherein an “OptSpace” algorithm completes the matrix in algorithm 3.

5. The system of any of paragraphs 1-4, wherein the algorithm recovers an ϵ-optimal ranking with high probability learnability.

6. The system of any of paragraphs 1-5, wherein the system allows as large as O(n) perturbed pairwise comparison results per model response

7. The system of any of paragraphs 1-6, wherein the system is deployed in crowdsourced environments with unscreened participants.

8. The system of any of paragraphs 1-7, wherein the alignment management system provides an algorithm 5 that completes incomplete responses by human participants,

9. The system of any of paragraphs 1-8, wherein the system filters adversarially corrupted responses (CURATRON).

10. The alignment management system of any of paragraphs 1-9, wherein the system fixes incomplete and adversarially corrupted responses

11. A computer-implemented method to train or guide alignment of preference data of large language models (LLM) in an artificial intelligence agent, the method comprising
obtaining raw data;
optionally, processing the raw data by algorithm 3, to provide an estimate of entries of P-hat (\hat{p}) for i≤j providing a ranking of responses dataset; and
processing the ranking of responses dataset with a robust principal component analysis (RPCA) algorithm to provide to provide a recovered dataset; and
processing the recovered dataset by algorithm 2 (procedure 2) to provide a pairwise ranking of the data comprising a revised PL dataset; when the data is fully observed and adversarially corrupted;
optionally, processing the raw data with an OptSpace algorithm (algorithm 4) to provide recovered data; and
processing the recovered data by algorithm 2 (procedure 2) to provide a pairwise ranking dataset comprising a revised PL dataset, when the data is partially observed and uncorrupted optionally, processing the raw data by a second OptSpace algorithm (algorithm 5) to provide recovered dataset; and
processing the recovered dataset by a robust principal component analysis (RPCA) (procedure 1) to provide a recovered dataset; and
processing the recovered dataset by algorithm 2) (procedure 2) to provide a pairwise ranking of the data comprising a revised PL, dataset when the data is partially observed and adversarially corrupted;
wherein a large language model (LLM) uses the revised PL dataset from the algorithms 3, 4, or 5 to align the LLM with user preferences.

12. The method of any of paragraph 11, wherein the first procedure provides raw data recovery.

13. The method of any of paragraphs 11-12, wherein the second procedure provides a pairwise ranking of the data.

14. The method of any of paragraphs 11-13, wherein the input to algorithms 3, 4 and 5 is N={(i, j, {y^{k}ᵢⱼ})}.

15. The method of any of paragraphs 11-14, wherein the output of algorithms 3, 4, and 5 is the ranking of n responses, \hat{σ}∈Sₙ.

16. The method of any of paragraphs 11-15, wherein the estimate of entries of \hat{p} for i≤j, in algorithm 3 is provided by:

$${\hat{P}}_{ij} = \{ \begin{matrix}\frac{1}{K} {\sum }_{k = 1}^{K} {y}_{ij}^{k} & if i < j \\ 1 / 2 & if i = j\end{matrix} .$$

17. The metho of any of paragraphs 11-16, wherein the estimate of entries of \hat{p} for i≤ j, in algorithm 4 is provided by:

$${\hat{P}}_{ij} = \{ \begin{matrix}\frac{1}{K} {\sum }_{k = 1}^{K} {y}_{ij}^{k} & if i < j and ( i , j ) ∈ Ω \\ 1 / 2 & if i = j and ( i , j ) ∈ Ω \\ 1 / 2 & if ( i , j ) ∉ Ω\end{matrix} .$$

18. The method of any of paragraphs 11-17, wherein the estimate of entries of \hat{p} for i≤j, in algorithm 5 is provided by:

$${\hat{P}}_{ij} = \{ \begin{matrix}\frac{1}{K} {\sum }_{k = 1}^{K} {y}_{ij}^{k} & if i < j and ( i , j ) ∈ Ω \\ 1 / 2 & if i = j and ( i , j ) ∈ Ω \\ 1 / 2 & if ( i , j ) ∉ Ω\end{matrix} .$$

19. The method of any of paragraphs 11-18, that is deployed in crowd-sourced environments with unscreened participants.

20. The method of any of paragraphs 11-19, wherein the algorithm recovers an ϵ-optimal ranking with high probability learnability.

21. The method of any of paragraphs 11-20, wherein direct preference optimization (DPO) is used to align LLMs with the revised data.

22. The method of any of paragraphs 11-20, wherein the RPCA algorithm is procedure 1.

All publications, patents, and patent documents cited herein are incorporated by reference as though individually incorporated by reference. No limitations inconsistent with this disclosure are to be understood therefrom. The invention has been described with reference to various specific and preferred embodiments and techniques. However, many variations and modifications may be made while remaining within the spirit and scope of the invention.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

What is claimed is:

1. A computer-implemented preference learning (PL) system to train alignment of preference data of large language models (LLM) in an artificial intelligence agent, the method comprising:
obtaining raw data;
optionally, when the data is fully observed and adversarially corrupted the data is processed by algorithm 3 (RORATRON) to provide an estimate of entries of P-hat for i≤j followed:
processed by a robust principal component analysis (RPCA) algorithm to provide completed data;
wherein the completed data is processed by algorithm 2 (procedure 2) to provide a pairwise ranking of the data comprising a revised PL dataset; and
optionally, when the data is partially observed and uncorrupted the raw data is processed by an OptSpace algorithm (algorithm 4) (CORATRON) to provide a completed dataset;
wherein the completed dataset is processed by algorithm 2 (procedure 2) to provide a pairwise ranking of the data comprising a revised PL dataset; and
optionally, when the data is partially observed and adversarially corrupted the raw data is processed by an OptSpace algorithm (algorithm 5) (CURATRON) to provide a recovered dataset;
wherein the recovered dataset followed by a robust principal component analysis (RPCA) algorithm to provide a completed dataset; and
wherein the completed dataset is processed by procedure 2 to provide a pairwise ranking of the data comprising a revised PL dataset;
wherein a large language model (LLM) uses the revised PL dataset from the algorithms 3, 4, or 5 to align the LLM with user preferences.

2. The alignment management system of claim 1, wherein direct preference optimization (DPO) is used to align the LLM with the revised data.

3. The alignment management system of claim 1, wherein the RPCA algorithm is procedure 1.

4. The alignment management system of claim 1, wherein an “OptSpace” algorithm completes the matrix in algorithm 3.

5. The alignment management system of any one of claim 1, wherein the algorithm 3 recovers an ϵ-optimal ranking with high probability learnability.

6. The alignment management system of any one of claim 1, wherein the system allows as large as O(n) perturbed pairwise comparison results per model response.

7. The alignment management system of any one of claim 1, wherein the system is deployed in crowdsourced environments with unscreened participants.

8. The alignment management system of any one of claim 1, wherein the system provides the algorithm 5 that completes incomplete responses by human participants.

9. The alignment management system of any one of claim 1, wherein the system corrects partially observed and uncorrupted responses (CURATRON).

10. The alignment management system of any one of claim 1, wherein the system corrects partially observed and adversarially corrupted responses.

11. A computer-implemented method to train or guide alignment of preference data of large language models (LLM) in an artificial intelligence agent, the method comprising:
obtaining raw data;
optionally, processing the raw data by algorithm 3, to provide an estimate of entries of P-hat (\hat{p}) for i≤j providing a ranking of responses dataset; and
processing the ranking of responses dataset with a robust principal component analysis (RPCA) algorithm to provide to provide a recovered dataset; and
processing the recovered dataset by algorithm 2 (procedure 2) to provide a pairwise ranking of the data comprising a revised PL dataset; when the data is fully observed and adversarially corrupted;
optionally, processing the raw data with an OptSpace algorithm (algorithm 4) to provide recovered data; and
processing the recovered data by algorithm 2 (procedure 2) to provide a pairwise ranking dataset comprising a revised PL dataset, when the data is partially observed and uncorrupted
optionally, processing the raw data by a second OptSpace algorithm (algorithm 5) to provide recovered dataset; and
processing the recovered dataset by a robust principal component analysis (RPCA) (procedure 1) to provide a recovered dataset; and
processing the recovered dataset by algorithm 2) (procedure 2) to provide a pairwise ranking of the data comprising a revised PL, dataset when the data is partially observed and adversarially corrupted;
wherein a large language model (LLM) uses the revised PL dataset from the algorithms 3, 4, or 5 to align the LLM with user preferences.

12. The method of claim 11, wherein the first procedure provides raw data recovery.

13. The method of claim 11, wherein the second procedure provides a pairwise ranking of the data.

14. The method of any one of claim 11, wherein the input to algorithms 3, 4 and 5 is N={(i, j, {y^{k}ᵢⱼ})}.

15. The method of any one of claim 11, wherein the output of algorithms 3, 4, and 5 is the ranking of n responses, \hat{σ}∈Sₙ.

16. The method of any one of claim 11, wherein the estimate of entries of \hat{p} for i≤j, in algorithm 3 is provided by:
$${\hat{P}}_{ij} = \{ \begin{matrix}\frac{1}{K} {\sum }_{k = 1}^{K} {y}_{ij}^{k} & if i < j \\ 1 / 2 & if i = j\end{matrix} .$$

17. The method of any one of claim 11, wherein an estimate of entries of \hat{p} for i≤j, in algorithm 4 is provided by:
$${\hat{P}}_{ij} = \{ \begin{matrix}\frac{1}{K} {\sum }_{k = 1}^{K} {y}_{ij}^{k} & if i < j and ( i , j ) ∈ Ω \\ 1 / 2 & if i = j and ( i , j ) ∈ Ω \\ 1 / 2 & if ( i , j ) ∉ Ω\end{matrix} .$$

18. The method of any one of claim 11, wherein the estimate of entries of \hat{p} for i≤j, in algorithm 5 is provided by:
$${\hat{P}}_{ij} = \{ \begin{matrix}\frac{1}{K} {\sum }_{k = 1}^{K} {y}_{ij}^{k} & if i < j and ( i , j ) ∈ Ω \\ 1 / 2 & if i = j and ( i , j ) ∈ Ω \\ 1 / 2 & if ( i , j ) ∉ Ω\end{matrix} .$$

19. The method of any one of claim 11 that is deployed in crowd-sourced environments with unscreened participants.

20. The method of any one of claim 11, wherein the algorithm recovers an ϵ-optimal ranking with high probability learnability.
